(19) United States
(12) Patent Application Publication
(10) Pub. No.: US 2023/0365831 A1
(43) Pub. Date: Nov. 16, 2023

(54) A COATING COMPOSITION, ITS PREPARATION AND USE THEREOF

(71) Applicant: BASF COATINGS GMBH, Münster (DE)

(72) Inventors: Christian Gerhard SCHAEFER, Shanghai (CN); Alex GROSCHOPP, Muenster (DE)

(21) Appl. No.: 18/245,516

(22) PCT Filed: Sep. 2, 2021
(86) PCT No.: PCT/EP2021/074227

§ 371 Date: Mar. 15, 2023

(30) Foreign Application Priority Data
Sep. 18, 2020 (WO) PCT/CN2020/116208

(51) Int. Cl. C09D 167/06; C09D 133/08; C09D 7/63; C09D 7/20; C09D 7/47

(52) U.S. Cl. CPC C09D 167/06; C09D 133/08; C09D 7/63; C09D 7/20; C09D 7/47

(57) ABSTRACT

Disclosed herein is a coating composition obtained by mixing a resin and/or hardener; a sagging control agent (SCA) reactive to resin and/or hardener; and a catalyst. Further disclosed herein are methods of preparing 1K and 2K coating compositions and using the coating compositions in an automotive to form a clearcoat.

### TECHNICAL FIELD

This invention relates to a coating composition especially an automotive coating composition, its preparation method and its use in automotive industry to form clearcoat.

### BACKGROUND

Rheology modifier, also called “Sagging Control Agent” (SCA) is crucial and indispensable for an automotive clearcoat formulation besides resin and hardener. SCAs are added into coating formulation to avoid sagging after being sprayed onto vertical surfaces. Normally SCAs are diurea crystallites dispersed in a liquid organic medium. At a low shear, a card-house structure based on hydrogen bonds between the urea functionalities leads to a high viscosity of the solution which impedes sagging of the solution on vertical surfaces, while during spraying process the high shear will result in anisotropic alignment of the particles and therefore, forms a lower viscosity applicable for spraying step.

SCAs are prepared by a reaction of amines with diisocyanates in a solution of a hydroxyl functional resin. Here, the diurea forms immediately and precipitates in a form of very tiny needle-shaped rheologically active crystals. The interaction between the hydrogen bonds of these crystals forms a three-dimensional and rheologically reactive network. This method has an advantage that the urea is already dispersed in the resin. However, it also limits its use for other clearcoat resins such as acid/epoxy, silane and/or unsaturated polymers. The SCAs in prior art are normally developed for 1K OH/melamine system or 2K polyurethane-based system. And resins used usually contain a certain amount of OH groups, which may lead to compatibility problems. Moreover, due to a high melting point of the crystallites, not all diurea particles will be homogenized in the liquid organic medium if no chemical reaction happens and consequently such inhomogeneity will cause a hazy appearance of the clearcoat.

Therefore, it is still required to find out a SCA that enables automotive coating formulations a good rheological performance and at the same time to obtain a clearcoat having balanced good properties.

### SUMMARY OF THIS INVENTION

In one aspect, the present invention provides a coating composition obtained by mixing components of
a). resin and/or hardener;
b). SCA (sagging control agent) reactive to resin and/or hardener; and
c). catalyst.

In another aspect, the present invention provides a method of preparing the invented coating composition by mixing resin, SCA, catalyst and optional initiator, leveling agent, reactive diluent and co-solvent.

In another aspect, the present invention provides a method of preparing the invented coating composition by mixing Component I comprising resin, SCA and optional reactive diluent and co-solvent, and Component II comprising hardener, catalyst and optional initiator and leveling agent.

In another aspect, the present invention provides a method of preparing the invented coating composition by mixing SCA, hardener and catalyst.

In another aspect, the present invention provides a method of preparing the invented coating composition by mixing Component I comprising SCA and catalyst, and Component II comprising hardener.

In another aspect, the present invention provides a use of the invented coating composition in automotive to form clearcoat.

In a further aspect, the present invention provides a clearcoat obtained by curing the invented coating composition.

It is surprising to find that a coating composition comprising silane based SCAs and/or hydroxyl group based SCAs and/or carbon double bond based SCAs could meet requirements of enabling a good rheological performance of coating solutions and at the same time being reactive to resins and/or hardeners in coating compositions and therefore avoiding appearance problems of clearcoat.

### DETAILED DESCRIPTION OF THE INVENTION

The following terms, used in the present description and the appended claims, have definitions as below:

Expressions “a”, “an”, “the”, when used to define a term, include both the plural and singular forms of the term.

All percentages are mentioned by weight unless otherwise indicated.

The term “and/or” includes the meanings “and”, “or” and also all the other possible combinations of the elements connected to this term.

The term “polymer”, as used herein, refers to homopolymers i.e. polymers prepared from a single reactive compound.

The term “copolymer”, as used herein, refers to polymers prepared by reaction of at least two polymer forming reactive, monomeric compounds.

The term “hardener”, as used herein, refers to a crosslinking agent or curing agent reactive to resins of coating compositions.

The term “2K” i.e. “two-component”, as used herein, refers to a composition comprising two components, each of which may also be a mixture of several compounds. The two components can be blended together if needed. And the two components may also be two independent barrels that can be mixed on the spot for applications.

The term “solid content”, as used herein, refers to a weight percentage of non-volatile materials contained in a suspension such as coating, paint etc.

The term “acid value”, as used herein, refers to the mass of potassium hydroxide (KOH) in milligrams that is required to neutralize one gram of chemical substance that is a measure of the number of carboxylic acid groups in a chemical compound or in a mixture of compounds.

The term “hydroxyl value”, as used herein, refers to the mass of potassium hydroxide (KOH) in milligrams that is required to neutralize the acetic acid taken up on acetylation of one gram of a chemical substance that contains free hydroxyl groups that is a measure of the content of free hydroxyl groups in a chemical substance.

The term “silane based SCA”, as used herein, refers to any SCA having at least one silane functional group.

The term “hydroxyl group based SCA”, as used herein, refers to any SCA having at least one hydroxyl functional group.

The term “carbon double bond based SCA”, as used herein, refers to any SCA having at least one carbon double bond.

The term “reactive diluent”, as used herein, refers to monomers playing a role of solvent for resins and later taking reactions with components of resins that have unsaturated groups.

The term “liquid organic medium”, as used herein, refers to resin or solvent that is used as base or matrix of SCAs.

The term “multi-functional isocyanate”, as used herein, refers to any isocyanate having at least two —NCO groups.

The term “hydroxy alkylamine”, as used herein, refers to alkanes substituted by hydroxyl and amine groups.

The term “multi-functional alkylamine”, as used herein, refers to alkanes substituted by at least two amine groups.

The objective of the present invention is to provide a coating composition comprising a sagging control agent that enables a good rheological performance of coating solutions and simultaneously reactive to resins and/or hardeners in the coating composition. The SCAs could be implemented into the polymer network and will not cause inhomogeneities that is often seen in conventional SCAs. Such inhomogeneities tend to bring haze and other problems to the appearance of clearcoat. According to the present invention, diurea could react with resins and/or hardeners having functions of isocyanate, (etherified) melamine-formaldehyde adducts, silane, acid or carbon double bond during baking and no residue will exist afterwards, and therefore, the gloss of the clearcoat will not be lowered.

The silane based SCAs or hydroxyl group based SCAs are synthesized by preloading diisocyanates in a liquid organic medium and adding aminosilane or aminoalcohol with dispersing the solution. In contrast to conventional SCAs, they are well compatible with silane-based or hydroxyl group-based resins and formulations. Additionally, they bring the coating solutions very strong anti-sagging properties which is beneficial for mechanical properties, chemical resistance and appearance of the obtained clearcoat.

The carbon double bond based SCAs are synthesized by preloading a diamine in a reactive diluent and adding an isocyanate having carbon double bond with dispersing the solution. They show strong rheological properties and the obtained clearcoat have good appearance. Double bond based SCAs could be applied to low VOC coating solutions with dispersing in reactive diluents.

The coating composition according to this invention comprises resin and/or hardener and at least one SCA selected from silane based SCA, hydroxyl group based SCA and carbon double bond based SCA as well as catalyst. Said coating composition could be prepared and used in 1K or 2K. As an example, the 1K coating composition comprises components of resin, SCA and catalyst. And in another example, the 1K coating composition comprises components of hardener, SCA and catalyst. As an example, the 2K coating composition comprises Component I comprising SCA and catalyst and Component II comprising hardener. And in another example, the 2K coating composition comprises Component I comprising resin and SCA and Component II comprising hardener and catalyst.

Three types of SCAs i.e. silane based SCA, hydroxyl group based SCA and carbon double bond SCA could be added separately or combined into coating compositions according to the reactive functions of resin and/or hardener.

Silane based SCA is obtained by a reaction of a multi-isocyanate of Formula (I):

R⁵—(NCO)_{y} Formula (I)

and a silane compound of Formula (II):

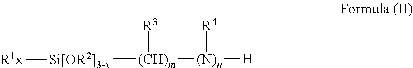

Wherein R¹ is independently C₁-C₁₂ alkyl group and preferably C₁-C₄ alkyl group; R² is independently C₁-C₆ alkyl group and preferably C₁-C₃ alkyl group; R³ is independently hydrogen or C₁-C₃ alkyl group; R⁴ is independently hydrogen or methyl or ethyl group; R⁵ is independently C₁-C₄ alkylene group or C₆-C₁₀ aryl group; y is an integer from 2 to 3; m is an integer from 1 to 3; n is an integer from 1 to 2; x is an integer from 0 to 2.

Preferably, the silane based SCA is preferably having a structure of Formula (III):

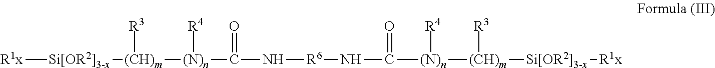

Wherein R¹ is independently C₁-C₁₂ alkyl group and preferably C₁-C₄ alkyl group; R² is independently C₁-C₆ alkyl group and preferably C₁-C₃ alkyl group; R³ is independently hydrogen or C₁-C₃ alkyl group; R⁴ is independently hydrogen or methyl or ethyl group; R⁶ is independently C₁-C₄ alkylene group or C₆-C₁₀ aryl group; m is an integer from 1 to 3; n is an integer from 1 to 2; x is an integer from 0 to 2.

The hydroxyl group based SCA is obtained by a reaction of a multi-functional isocyanate with at least one hydroxy alkylamine in a liquid organic medium comprising at least one hydroxy-functional resin selected from polyacrylate, polyester, polyurethane and polycarbonate and at least one organic solvent selected from butylacetate, solvent naphtha, dimethylsulfoxide or N-Methyl-2-pyrrolidone.

The carbon double bond based SCA is obtained by a reaction of an isocyanic (meth)acrylate with at least one multi-functional alkylamine in a liquid organic medium comprising at least one (meth)acrylate-based reactive diluent selected from trimethylolpropane triacrylate and 1,6-hexanediol diacrylate and/or at least one organic solvent selected from butylacetate, solvent naphtha, dimethylsulfoxide or N-Methyl-2-pyrrolidone.

Resin is preferably a vinyl silane containing polyacrylate and/or a vinyl silane containing copolymer of acrylate and styrene and/or an unsaturated polyester. And said unsaturated polyester is preferably obtained from a reaction of itaconic acid, hexahydrophthalic anhydride and acrylated-based reactive diluent.

The hardener is preferably a blocked polyisocyanate hardener. The blocked polyisocyanate is obtained from reactions of components comprising at least one polyisocyanate selected from aliphatic polyisocyanate, cycloaliphatic polyisocyanate and polyisocyanate-functional polymer; and at least one beta-diketone.

The polyisocyanates on which the blocked polyisocyanates are based are known polyisocyanates comprising aliphatically and/or cycloaliphatically bonded isocyanate groups and/or polyisocyanate-functional polymer and the content of isocyanate (NCO) groups is from 10% to 50% and preferably from 15% to 35% by weight. Preferably, the polyisocyanates at least one selected from hexamethylene diisocyanate, hexamethylene diisocyanate trimer, 4,4′-dicyclohexylmethane diisocyanate and polyisocyanate-functional aliphatic acrylic ester. Polyisocyanates based on other isocyanates could also be used, for example diisocyanatobutane-1,4,2,4-cyclohexane, 2,6-diisocyanato-1-methylcyclohexane, 2,5-bis-isocyanato-norbornane, 2,6-bis-isocyanato-norbornane, 3-isocyanatomethyl-1-methylcyclohexane, 4-isocyanatomethyl-1-methylcyclohexane, 1,4-bis-(2-isocyanato-prop-2-yl)-benzene, 1,3-diisocyanatomethylbenzene, 1,3-bis-isocyanatomethylcyclohexane and 1,4-bis-isocyanatomethylcyclohexane.

The beta-diketone is reacted with partial of NCO groups of polyisocyanates. Preferably the beta-diketone is at least one selected from 1,3-indandione, 1-(2-aminophenyl)decane-1,3-dione, 2′-O-methyllicodione, 2,4,4′,6-tetrahydroxydibenzoylmethane, 2,4-dioxopentanedioic acid, Ethyl 2-oxocyclopentanecarboxylate, 2-[(2,6-dioxocyclohexyl)methyl]cyclohexane-1,3-dione, 2-[(4,4-dimethyl-2,6-dioxocyclohexyl)methyl]-5,5-dimethylcyclohexane-1,3-dione, 2-[1-(2,6-dioxocyclohexyl)-3-phenylprop-2-ynyl]cyclohexane-1,3-dione, 2-cyano-3-cyclopropyl-1-(2-mesyl-4-trifluoromethylphenyl)propan-1,3-dione, 3,5-dioxooctanedioic acid, 3,6-dihydroxycyclohexane-1,2,4,5-tetrone, 3-dehydro-scyllo-inosose, 3-fumarylpyruvic acid, 3-hydroxy-2,4-dioxopentyl phosphate, 3-maleylpyruvic acid, 3-undecylcyclohexane-1,2,4,5-tetrone, 4,6-dioxohept-2-enedioic acid, 4,6-dioxoheptanoic acid, 4-(2-aminophenyl)-2,4-dioxobutanoic acid, 4-(3-methyl-5-isoxazolyl)-5-phenylcyclohexane-1,3-dione, 4-[4-(3,5-dioxohexyl)phenylcarbamoyl]butyric acid, 4-fumarylacetoacetic acid, 4-maleylacetoacetic acid, 5,7-icosanedione, 5-(2,2-diferuloylethen-1-yl)thalidomide, 5-(2-furanyl)cyclohexane-1,3-dione, 5-(hydroxymethyl)-3-(1-oxohexadecyl)oxolane-2,4-dione, 5-ethylundecane-2,4-dione, 5-hydroxy-2,4-dioxopentanoic acid, 6,8-icosanedione, 6-Gingerdione, acetylacetone, acetylpyruvic acid, alpha-acetylbutyrolactone, anisindione, berkeleydione, berkeleytrione, bicyclo[2.2.2]octane-2,6-dione, bicyclopyrone, bisdemethoxycurcumin, clethodim, curcumin, cyclohexane-1,3-dione, cyclopentane-1,3-dione, cycloxydim, demethoxycurcumin, dibenzoylmethane, dihydrocurcumin, hentriacontane-14,16-dione, licodione, ninhydrin, nonane-4,6-dione, phenindione, tenuazonic acid, tetrahydrocurcumin and tritriacontane-16,18-dione. More preferably, the beta-diketone is at least one selected from ethyl 2-oxocyclopentanecarboxylate and/or alpha-acetylbutyrolactone.

The catalyst is phosphorus-containing and/or nitrogen-containing and/or transition metal catalysts. In this context it is also possible to use mixtures of two or more different catalysts.

Examples of suitable phosphorus-containing catalysts are substituted phosphonic diesters and diphosphonic diesters, preferably from the group consisting of acyclic phosphonic diesters, cyclic phosphonic diesters, acyclic diphosphonic diesters and cyclic diphosphonic diesters. Catalysts of this kind are described in German Patent Application DE-A-102005045228, for example. More particularly, however, substituted phosphoric monoesters and phosphoric diesters are used, preferably from the group consisting of acyclic phosphoric diesters and cyclic phosphoric diesters, more preferably amine adducts of phosphoric monoesters and diesters.

Examples of suitable nitrogen-containing catalysts are tertiary amines, examples being bicyclic amines, such as diazabicyclooctane (DABCO), diazabicyclononene (DBN), diazabicycloundecene (DBU), dimethyldodecylamine or triethylamine.

Examples of suitable transition metal catalysts are tin, bismuth, zinc, zirconium, manganese or mixed bimetallic organyls or complexes, examples being carboxylates, such as dibutyltin dilaurate (DBTL), Bismuth-trisoctoate (Bi-TOCE), Zinc-neodecanoate (Zn-NDE), Zirconium-laurate (Zr-L) or Manganese-decanoate (Mn-DCE).

Used with especial preference as catalyst are the corresponding amine-blocked phosphoric esters, and, of these, more particularly amine-blocked ethylhexyl phosphates and amine-blocked phenyl phosphates, especially preferably amine-blocked phosphoric acid bis(2-ethylhexyl) esters.

Examples of amines with which the phosphoric esters are blocked are, in particular, tertiary amines, examples being bicyclic amines, such as diazabicyclooctane (DABCO), diazabicyclononene (DBN), diazabicycloundecene (DBU), dimethyldodecylamine or triethylamine, for example. Particularly preferred for blocking the phosphoric esters is the use of tertiary amines, which ensure high activity of the catalyst at the curing conditions of 140° C.

Certain amine-blocked phosphoric acid catalysts are also available commercially (e.g. Nacure products from King Industries). An example that may be mentioned is that with the designation Nacure 4575 from King Industries, as a particularly suitable catalyst based on an amine-blocked phosphoric acid partial ester.

The coating composition could further comprise initiator, reactive diluent, co-solvent and leveling agent.

The radical initiator is either peroxide or azo-initiator and preferably non-peroxide or non-azo initiator, examples being 2-oxocyclopentanecarboxylate and/or benzo pinacol.

The reactive diluent has reactive double bonds. Preferably, the reactive diluent is at least one selected from methyl acrylate, methyl methacrylate, ethyl acrylate, ethyl methacrylate, propyl acrylate, propyl methacrylate, isopropyl acrylate, isopropylmethacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, 2-ethylhexyl acrylate, 2-ethylhexyl methacrylate, 3,3,5-trimethylhexyl acrylate, 3,3,5-trimethylhexyl methacrylate, cyclohexyl acrylate, cyclohexyl methacrylate, isobornyl acrylate, isobornyl methacrylate, norbonyl acrylate, norbonyl methacrylate, adamantyl acrylate, 1,4-butanediol diacrylate, 1,4-butanediol dimethacrylate, 1,6-hexanediol diacrylate, 1,6-hexanediol dimethacrylate, trimethylolpropane triacrylate, trimethylolpropane trimethacrylate, ethoxylated diacrylate, ethoxylated dimethacrylate, ethoxylated triacrylate, ethoxylated trimethacrylate, pentaerythritol tetraacrylate, pentaerythritol tetramethacrylate, di(trimethylolpropane) tetraacrylate and di(trimethylolpropane) tetramethacrylate.

Co-solvents suitable for the coating composition of the invention are especially those which in the coating material are chemically inert towards the resin and/or hardener and which also do not react with the catalyst and/or initiator during the curing of the coating material. Examples of non- to low-polar solvents are aliphatic and/or aromatic hydrocarbons such as toluene, xylene, solvent naphtha, Solvesso 100 or Hydrosol® (ARAL), ketones, such as acetone, methyl ethyl ketone or methyl amyl ketone, esters, such as ethyl acetate, butyl acetate, pentyl acetate or ethyl ethoxypropionate, ethers, or mixtures of the aforesaid solvents. Examples of polar solvents or respective solvent mixtures are 1-butanol, butyl glycol, dimethylsulfoxide or N-Methyl-2-pyrrolidone.

The coating composition according to this invention has a good anti-sagging property and the obtained clearcoat after curing also shows satisfying mechanical properties and no appearance problem occurs.

### Embodiments

The following embodiments are used to illustrate the invention in more details.

The 1^{st} embodiment is a coating composition obtained by mixing components of
a). resin and/or hardener;
b). SCA (sagging control agent) reactive to resin and/or hardener; and
c). catalyst.

The coating composition according to the 1^{st} embodiment, wherein said SCA is at least one selected from silane based SCA, hydroxyl group based SCA and carbon double bond based SCA.

The coating composition according to any one of embodiments 1 to 2, wherein said silane based SCA is preferably obtained by a reaction of a multi-isocyanate of Formula (I):

R⁵—(NCO)_{y} Formula (I)

and a silane compound of Formula (II):

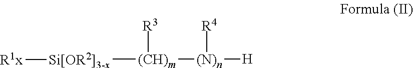

Wherein R¹ is independently C₁-C₁₂ alkyl group and preferably C₁-C₄ alkyl group; R² is independently C₁-C₆ alkyl group and preferably C₁-C₃ alkyl group; R³ is independently hydrogen or C₁-C₃ alkyl group; R⁴ is independently hydrogen or methyl or ethyl group; R⁵ is independently C₁-C₄ alkylene group or C₆-C₁₀ aryl group; y is an integer from 2 to 3; m is an integer from 1 to 3; n is an integer from 1 to 2; x is an integer from 0 to 2.

The coating composition according to the 3^{rd} embodiment, wherein said silane based SCA is preferably having a structure of Formula (III):

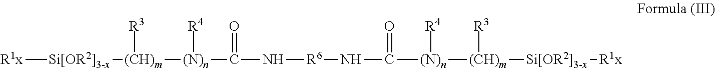

Wherein R¹ is independently C₁-C₁₂ alkyl group and preferably C₁-C₄ alkyl group; R² is independently C₁-C₆ alkyl group and preferably C₁-C₃ alkyl group; R³ is independently hydrogen or C₁-C₃ alkyl group; R⁴ is independently hydrogen or methyl or ethyl group; R⁶ is independently C₁-C₄ alkylene group or C₆-C₁₀ aryl group; m is an integer from 1 to 3; n is an integer from 1 to 2; x is an integer from 0 to 2.

The coating composition according to any one of embodiments 1 to 2, wherein said hydroxyl group based SCA is preferably obtained by a reaction of a multi-functional isocyanate with at least one hydroxy alkylamine in a liquid organic medium comprising at least one hydroxy-functional resin selected from polyacrylate, polyester, polyurethane and polycarbonate and at least one organic solvent selected from butylacetate, solvent naphtha, dimethylsulfoxide or N-Methyl-2-pyrrolidone.

The coating composition according to any one of embodiments 1 to 2, wherein said carbon double bond based SCA is preferably obtained by a reaction of an isocyanic (meth)acrylate with at least one multi-functional alkylamine in a liquid organic medium comprising at least one (meth)acrylate-based reactive diluent selected from trimethylolpropane triacrylate and 1,6-hexanediol diacrylate and/or at least one organic solvent selected from butylacetate, solvent naphtha, dimethylsulfoxide or N-Methyl-2-pyrrolidone.

The coating composition according to any one of embodiments 1 to 6, wherein said resin is preferably a vinyl silane containing polyacrylate and/or a vinyl silane containing copolymer of acrylate and styrene and/or an unsaturated polyester.

The coating composition according to the 7^{th} embodiment, wherein said unsaturated polyester is preferably obtained from a reaction of itaconic acid, hexahydrophthalic anhydride and acrylated-based reactive diluent.

The coating composition according to any one of embodiments 1 to 8, wherein said hardener is preferably a blocked polyisocyanate hardener.

The coating composition according to any one of embodiments 1 to 9, wherein it further comprises at least one selected from initiator, reactive diluent, co-solvent and leveling agent.

The coating composition according to any one of embodiments 1 to 10, wherein its solid content is no less than 60% by weight.

The coating composition according to any one of embodiments 1 to 11, wherein the ratio of low shear viscosity η₂ and high shear viscosity η₁ is no less than 2.

The coating composition according to any one of embodiments 1 to 12, wherein its VOC (volatile organic compounds) content is less than 400 g/L.

A method of preparing the coating composition according to any one of embodiments 1 to 13 by mixing resin, SCA, catalyst and optional initiator, leveling agent, reactive diluent and co-solvent.

A method of preparing the coating composition according to any one of embodiments 1 to 13 by mixing Component I comprising resin, SCA and optional reactive diluent and co-solvent, and Component II comprising hardener, catalyst and optional initiator and leveling agent.

A method of preparing the coating composition according to any one of embodiments 1 to 13 by mixing SCA, hardener and catalyst.

A method of preparing the coating composition according to any one of embodiments 1 to 13 by mixing Component I comprising SCA and catalyst, and Component II comprising hardener.

A use of the coating composition according to any one of embodiments 1 to 13 in automotive to form clearcoat.

A clearcoat obtained by curing the coating composition according to any one of embodiments 1 to 13.

The clearcoat according to the 19^{th} embodiment, wherein its MEK (methylethylketone) double rub value is no less than 300 and preferably no less than 400.

The clearcoat according to any one of embodiments 19 to 20, wherein its gloss (20⁰) is no less than 85% and its haze is less than 20.

### EXAMPLES

The present invention will now be described with reference to Examples which are not intended to limit the present invention.

### Example 1: Silane-Based SCA

44.25 g of 3-aminopropyltriethoxysilane is dissolved in 37.05 g of butylacetate and then given into a 1 L metal bucket which contains 370.43 g of butylacetate. This solution is mixed by a dissolver 2 min at 2000 rpm. Then 16.53 g of hexamethylene diisocyanate is dissolved in 31.74 g butylacetate and loaded into an automatic dosing machine. The liquid in the metal bucket is stirred by a dissolver with a velocity 2000 rpm. The isocyanate solution is then added dropwise over the course of 20 minutes. After that step, the solution is kept in the disperser for 2 additional minutes. Total solid content 12 wt %, η₁ (shear rate=1000 s⁻¹)=46 mPa·s, η₂ (shear rate=1 s⁻¹)=13759 mPa·s.

### Example 2: Silane-Based SCA

88.50 g of 3-aminopropyltriethoxysilane is dissolved in 37.05 g of butylacetate and then given into a 1 L metal bucket which contains 293.78 g of butylacetate. This solution is mixed by a dissolver 2 min at 2000 rpm. Then 33.06 g of hexamethylene diisocyanate is dissolved in 47.61 g butylacetate and loaded into an automatic dosing machine. The liquid in the metal bucket is stirred by a dissolver with a velocity 2000 rpm. The isocyanate solution is then added dropwise over the course of 30 minutes. After that step, the solution is kept in the disperser for 2 additional minutes. Total solid content 24 wt %, η₁ (shear rate=1000 s⁻¹)=60 mPa·s, η₂ (shear rate=1 s⁻¹)=16833 mPa·s.

### Example 3: OH-Based SCA

2.11 g of ethanolamine is dissolved in 25.4 g of butylacetate and then given into a 1 L metal bucket which contains 436.66 g of the acrylate-based polyol resin (hydroxy value of 104 mg KOH/g, acid value of 15 mg KOH/g, glass transition temperature of 19° C., weight-average molecular weight of 9600 g/mol). This solution is mixed by a dissolver 2 min at 2000 rpm. Then 6.54 g of hexamethylene diisocyanate trimer Desmodur N3300 (Covestro) is dissolved in 24.95 g butylacetate and loaded into an automatic dosing machine. The liquid in the metal bucket is stirred by a dissolver with a velocity 2000 rpm. The isocyanate solution is then added dropwise over the course of 10 minutes. After that step, the solution is kept in the disperser for 2 additional minutes. Total solid content 54.4 wt %, η₁ (shear rate=1000 s⁻¹)=840 mPa·s, η₂ (shear rate=1 s⁻¹)=3995 mPa·s.

### Example 4: OH-Based SCA

5.85 g of 2-amino-1-butanol is dissolved in 39.45 g of butylacetate and then given into a 1 L metal bucket which contains 411.30 g of the OH acrylate resin (hydroxy value of 104 mg KOH/g, acid value of 15 mg KOH/g, glass transition temperature of 19° C., weight-average molecular weight of 9600 g/mol). This solution is mixed by a dissolver 2 min at 2000 rpm. Then 5.44 g of hexamethylene diisocyanate is dissolved in 16.90 g butylacetate and loaded into an automatic dosing machine. The liquid in the metal bucket is stirred by a dissolver with a velocity 2000 rpm. The isocyanate solution is then added dropwise over the course of 10 minutes. After that step, the solution is kept in the disperser for 2 additional minutes. Total solid content 56 wt %, η₁ (shear rate=1000 s⁻¹)=526.44 mPa·s, η₂ (shear rate=1 s⁻¹)=11873 mPa·s.

### Example 5: Carbon Double Bond Based SCA

12.073 g of 2-isocyanatoethyl methacrylate is dissolved in 16.915 g of butylacetate and then given into a 1 L metal bucket which contains 436.66 g of Trimethylolpropane triacrylate. This solution is mixed by a dissolver 2 min at 2000 rpm. Then 4.7 g of hexamethylene diamine is dissolved in 28.124 g butylacetate and loaded into an automatic dosing machine. The liquid in the metal bucket is stirred by a dissolver with a velocity 2000 rpm. The isocyanate solution is then added dropwise over the course of 10 minutes. After that step, the solution is kept in the disperser for 2 additional minutes. Total solid content 56 wt %, q, (shear rate=1000 s⁻¹)=125 mPa·s, η₂ (shear rate=1 s⁻¹)=21839 mPa·s.

### Example 6: Carbon Double Bond Based SCA

12.073 g of 2-isocyanatoethyl methacrylate is dissolved in 16.915 g of butylacetate and then given into a 1 L metal bucket which contains 436.66 g of 1,6-Hexanediol diacrylate. This solution is mixed by a dissolver 2 min at 2000 rpm. Then 4.7 g of hexamethylene diamine is dissolved in 28.124 g butylacetate and loaded into an automatic dosing machine. The liquid in the metal bucket is stirred by a dissolver with a velocity 2000 rpm. The isocyanate solution is then added dropwise over the course of 10 minutes. After that step, the solution is kept in the disperser for 2 additional minutes. Total solid content 56 wt %, η₁ (shear rate=1000 s⁻¹)=37 mPa·s, η₂ (shear rate=1 s⁻¹)=6268 mPa·s.

### Example 7: Preparation of a Vinyl Silane Containing Acrylate/Styrene Copolymer

A reactor is charged with 378 parts by weight of butyl acetate (BA) and this initial charge is heated to 145° C. The reactor is placed under pressure (3.5 bar). Thereafter, over a period of 5.38 hours, an initiator solution (82.9 parts by weight of di-tert-butyl peroxide in 62.5 parts by weight of BA) is metered in at a uniform rate with stirring. After 15 of start of initiator feed, 576.8 parts by weight of VTMS is metered in at a uniform rate with stirring over a period of 1 hour. In the first step, a monomer mixture consisting of 87.1 parts by weight of styrene, 87.1 parts by weight of methyl methacrylate and 108.8 parts by weight of n-butyl acrylate is simultaneously metered in at a uniform rate with stirring over a period of 1 hour. In the second step, a monomer mixture consisting of 113.3 parts by weight of styrene, 113.3 parts by weight of methyl methacrylate and 141.6 parts by weight of n-butyl acrylate is simultaneously metered in at a uniform rate with stirring over a period of 1 hour. In the third step, a monomer mixture consisting of 78.4 parts by weight of styrene, 78.4 parts by weight of methyl methacrylate and 98 parts by weight of n-butyl acrylate is simultaneously metered in at a uniform rate with stirring over a period of 1 hour. In the fourth step, a monomer mixture consisting of 39.5 parts by weight of styrene, 39.5 parts by weight of methyl methacrylate and 49.4 parts by weight of n-butyl acrylate is simultaneously metered in at a uniform rate with stirring over a period of 1 hour. In the fifth step, a monomer mixture consisting of 11.4 parts by weight of styrene, 11.4 parts by weight of methyl methacrylate and 14.2 parts by weight of n-butyl acrylate is simultaneously metered in at a uniform rate with stirring over a period of 1 hour. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of BA is again added at a uniform rate over the course of 1.2 hours. Subsequently, the batch is held at the stated temperature and stated pressure for a further 1.1 hours. Thereafter the reaction mixture is cooled to 60° C. and let down to atmospheric pressure. The solids content of the resulting copolymer solution is 75.4%. The copolymer possesses a weight-average molecular weight of 9936 g/mol. The glass transition temperature of the copolymer is 4.8° C.

### Example 8: Preparation of Unsaturated Polyester Based on Itaconic Acid and Hexahydrophthalic Anhydride in Reactive Diluents

210 g of trimethylol propane, 503 g itaconic acid, 329 g 1,4-butandiol, 12 g Xylene, 0.5 g MEHQ and 1.5 g BHT have been placed in a reactor, heat up to 100° C. and kept for 1 hour. The temperature has been increased to 160° C. and kept for another hour before increasing to 230° C. and kept for 2 hours. Xylene has been distilled off during the reaction. Cooling to 80° C. and adding 322 g hexohydrophthalic anhydride, 100 mg BHT and 80 mg MEHQ (hydroquinone monomethyl ether) to the mixture and heating up to 140° C. for several hours.

Adding 623 g Cadura E10P, 100 mg BHT and 80 mg MEHQ to the reaction mixture over 1.5 hours, cool down to 40° C. and adding 500 g trimethylolpropane triacrylate and 500 g 1,6-hexandiol diacrylate. The reaction leads to a solvent-free low viscous unsaturated polyester resin (67% in reactive diluents) with acid value of 10-50 mg KOH/g, hydroxy value of 100-300 mg KOH/g and glass transition temperature of −55° C.

### Example 9: Preparation of Blocked Polyisocyanate Hardener

330.2 g (0.51 mol) of HDI (Hexamethylene diisocyanate)-trimer (Evonik Desmodur N3300) and 20 mg catalyst sodium methoxylate have been placed in a flask under nitrogen atmosphere. 80 g (0.16 mol)) of Ethyl 2-oxocyclopentanecarboxylate has been added dropwise at room temperature, whereas the reaction temperature increased to 40° C. at the end. External heating to 80° C. and stirring under nitrogen has been followed until NCO content has been at the calculated value. Reaction mixture has been cooled to room temperature, 189.8 g (0.31 mol) of 2-(tert-butylamino)ethylmethacrylate (Sinopharm) has been added dropwise and temperature kept between 35-45° C. until NCO content has been 0%. 600 g of a slightly yellowish liquid has been obtained which was further diluted into mixtures of reactive diluters HDDA and TMPTA in different ratios (100:0% to 0:100%). Rest initiator content was below HPLC detection limit <0.01%.

### Example 10: Preparation and Spray Application of 1K Silane Clearcoat Composition

According to the amount given in the Table below, acrylate/styrene resin having silane functional groups, unsaturated polyester resin, acrylate-based reactive diluent (trimethylolpropane triacrylate, TMPTA), silane-based sagging control agent (SCA), catalyst (Narcure 4575, King Industries), initiator (benzo pinacol, BP), co-solvent (1-butanol) and additives of leveling agent (BYK 3190) are mixed evenly to obtain a 1K clearcoat composition as Example 10. The coating composition showed thixotropic behavior with a ratio of low-shear viscosity η₂ (shear rate=1 s⁻¹) to high-shear viscosity q, (shear rate=1000 s⁻¹)>8. VOC value of the coating composition has been measured to be 325 g/L which is a strong reduction in VOC level compared to conventional 1K coating compositions (VOC=450-550 g/L). The composition is spray applied on black basecoat coated tin panels and placed at 140° C. for 20 min. After 3 days of post curing single layer tests for performance check are conducted by evaluating the hardness (Koenig's pendulum), crosslinking density (MEK double rub test) as well as gloss and haze measurement (specular reflection). From Example 10, it can be clearly seen that the invented technical approach can deliver high solid content and low VOC value, exceptional high crosslinking performance as well as good appearance.

TABLE 1
Composition of Example 10

| | | | Example 10 |
|---|---|---|---|
| Composition | Resin | Example 7: Vinyl Silane | 37.6 |
| (g) | | Containing Acrylate/ | |
| | | Styrene Copolymer | |
| | | Example 8: Unsaturated | 11.3 |
| | | Polyester | |
| | SCA | Example 1: Silane-based | 6 |
| | | Sagging Control Agent | |
| | Catalyst | NARCURE 4575 | 4.5 |
| | Initiator | Benzo pinacol | 1.1 |
| | Additive | BYK 3190 | 0.4 |
| | Reactive | TMTPA | 27.8 |
| | diluent | | |
| | Co-solvent | 1-Butanol | 11.3 |

| | | |
|---|---|---|
| Performance | Solid Content (%) | 67.2 |
| | Koenigs Pendulum (oscillations) | 113 |
| | MEK Double Rub (times) | 500+ |
| | VOC (g/L) | 325 |
| | Gloss (20°) | 92 |
| | Haze | 13 |

### Example 11: Preparation and Spray Application of 2K Low VOC Clearcoat Composition

According to the amount given in the Table below, unsaturated polyester resin, acrylate-based reactive diluents (trimethylolpropane triacrylate, TMPTA and 1,6 heanediol diacrylate), carbon double bond-based sagging control agent (SCA) and co-solvent (butyl acetate) are mixed evenly to obtain Component A. Blocked polyisocyanate hardener, catalyst (1,8-Diazabicyclo[5.4.0]undec-7-ene, DBU and Borchers Deca Manganese 8), initiator (benzo pinacol, BP), and additives of leveling agent (BYK 378) are mixed evenly to obtain Component B. Before application, Component A and component B are mixed evenly to obtain a 2K clearcoat composition as Example 11. The coating composition showed thixotropic behavior with a ratio of low-shear viscosity η₂ (shear rate=1 s⁻¹) to high-shear viscosity η₁ (shear rate=1000 s⁻¹)>2.5. VOC value of the coating composition has been measured to be 125 g L⁻¹ which is a strong reduction in VOC level compared to conventional 2K coating compositions (VOC=450-550 g L⁻¹). The composition is spray applied on black basecoat coated tin panels and placed at 140° C. for 20 min. After 3 days of post curing single layer tests for performance check are conducted by evaluating the hardness (Koenig's pendulum), crosslinking density (MEK double rub test) as well as gloss and haze measurement (specular reflection). From Example 11, it can be clearly seen that the invented technical approach can deliver high solid content and exceptional low VOC value as well as good appearance.

TABLE 2
Composition of Example 11

| | | | Example |
|---|---|---|---|
| | | | 11 |
| Component A | Resin | Example 8: Unsaturated | 11.2 |
| composition | | Polyester | |
| (g) | SCA | Example 5: carbon double | 14.3 |
| | | bond based SCA | |
| | Reactive | TMTPA | 3.0 |
| | diluent | HDDA | 6.0 |
| | Co-solvent | Butyl acetate | 1.8 |
| Component B | Hardener | Example 9: Blocked isocyanate | 13.3 |
| composition | | hardener | |
| (g) | Catalyst | DBU | 0.1 |
| | | Borchers Deca Manganese 8 | 0.02 |
| | Initiator | Benzo pinacol | 0.5 |
| | Additive | BYK 378 | 0.1 |

| | | |
|---|---|---|
| Performance | Solid Content (%) | 87.3 |
| | Koenigs Pendulum (oscillations) | 107.0 |
| | MEK Double Rub (times) | 410.0 |
| | VOC (g/L) | 125.0 |
| | Gloss (20°) | 86.0 |
| | Haze | 11.0 |

### Example 12: Preparation and Application of 1K Melamine/OH Clearcoat Composition

According to the amount given in the Table below, OH-based sagging control agent (SCA), melamine resin (Luwipal 018), catalyst (Narcure 4045, King Industries) and solvent (solvent naphtha 160/180) are mixed evenly to obtain a 1K clearcoat composition as Example 11. The coating composition showed thixotropic behavior with a ratio of low-shear viscosity η₂ (shear rate=1 s⁻¹) to high-shear viscosity η₁ (shear rate=1000 s⁻¹)>10. The composition is applied by using a doctor blade on black basecoat coated tin panels and placed at 140° C. for 20 min. After 3 days of post curing single layer tests for performance check are conducted by evaluating the hardness (Koenig's pendulum), crosslinking density (MEK double rub test) as well as gloss and haze measurement (specular reflection). From Example 12, it can be clearly seen that the invented technical approach can deliver exceptional good appearance.

TABLE 3
Composition of Example 12

| | | | Example 12 |
|---|---|---|---|
| Composition (g) | SCA | Example 4: OH-based SCA | 69.3 |
| | Hardener | Luwipal 018 | 29.7 |
| | Catalyst | NARCUR 4045 | 1 |

| | | |
|---|---|---|
| Performance | Solid Content (%) | 60.2 |
| | Koenigs Pendulum (oscillations) | 113 |
| | MEK Double Rub (times) | 450 |
| | VOC (g/L) | 390 |
| | Gloss (%@20°) | 95 |
| | Haze | 9 |

### Example 13: Preparation and Application of 2K Isocyanate/OH Clearcoat Composition

According to the amount given in the Table below, OH-based sagging control agent (SCA) and catalyst (1,8-diazabicyclo[5.4.0]undec-7-ene, DBU) are mixed evenly to obtain Component A. Polyisocyanate hardener (Desmodur 3390) was used as Component B. Before application, Component A and Component B are mixed evenly to obtain a 2K clearcoat composition as Example 13. The composition is applied by using a doctor blade on black basecoat coated tin panels and placed at 140° C. for 20 min. After 3 days of post curing single layer tests for performance check are conducted by evaluating the hardness (Koenig's pendulum), crosslinking density (MEK double rub test) as well as gloss and haze measurement (specular reflection). From Example 13, it can be clearly seen that the invented technical approach can deliver exceptional good appearance.

TABLE 4
Composition of Example 13

| | | | Example 13 |
|---|---|---|---|
| Component A | SCA | Example 4: OH-based SCA | 71 |
| composition (g) | Catalyst | DBU | 0.5 |
| Component B | Hardener | Desmodur 3390 | 28.5 |
| composition (g) | | | |

| | | |
|---|---|---|
| Performance | Solid Content (%) | 60.2 |
| | Koenigs Pendulum (oscillations) | 113 |
| | MEK Double Rub (times) | 450 |
| | VOC (g/L) | 345 |
| | Gloss (%@20°) | 89 |
| | Haze | 12 |

### Resin Characterization

The skilled person is aware of methods for determining the acid value, OH value, solid content as well as number-average and weight-average molecular weights. They are determined in accordance with the standards described hereinafter:

The acid value is determined in accordance with DIN EN ISO 2114 (date: June 2002). The OH value is determined in accordance with DIN 53240-2 (date: November 2007). The solid content was determined in accordance with DIN EN ISO 3251 (date: June 2008). The number-average and weight-average molecular weights are determined in accordance with DIN 55672-1 (date: August 2007).

### Solid Content

Solid contents of the clearcoat compositions of Example 10 to 12 is calculated based on the weight loss of the composition at 130° C. for 60 minutes.

### Performance Tests

(1) Hardness

The pendulum damping test after Koenig or Persoz is used to mechanically measure the surface hardness of a coating. The hardness of the coating is determined by the number of oscillations made by the pendulum between two defined angles (6 to 3 degrees for Koenig pendulum or 12 to 4 degrees for Persoz pendulum). With increasing hardness of the coating surface, the number of oscillations is increasing. The number of oscillations for conventional 2K polyurethane or acid/epoxy clearcoat is >100. The methods are standardized in the specification ISO 1522.
(2) Solvent Rub Test

To assess the crosslinking and to ensure the coating system has been cured, a solvent rub test is performed using methylethylketone (MEK) as the solvent. The test is used widely in the paint industry because it provides a quick relative estimation of degree of cure without having to wait for long-term exposure results. The rubs are counted as a double rub (one rub forward and one rub backward constitutes a double rub) which gives a measurable value for the MEK resistance and degree of cure. The MEK double rub values of conventional 2K polyurethane or acid/epoxy clearcoat is about 200 times.
(3) VOC Test

To determine the volatile organic compounds (VOCs) emission of the coating compositions a gravimetric method was applied. The VOC content was measured on the basis of the weight loss of the composition when heated to 105° C. for 60 min.
(4) Rheology Test

The thixotropic effect of the sagging control agents as well as the coating compositions was characterized by using an Anton Paar rheometer. The 2D rheology profile was measured by fast shear rate changes. The test consists of two intervals with two different shear rates (shear rate 1=1 s⁻¹), shear rate 2=1000 s⁻¹). The thixotropic index is defined as the ratio between the viscosity of a sample at a high (η₂) and at a low (η₁) shear.
(5) Gloss & Haze Measurement

The Gloss and Haze of the dried and cured coating is evaluated by measuring the specular reflection gloss of the surface by using a gloss meter. Gloss is determined by projecting a beam of light at a fixed intensity and angle onto the surface and measuring the amount of reflected light at an equal but opposite angle of 20° and 60°, respectively. Haze is caused by microscopic surface structure which slightly changes the direction of a reflected light causing a bloom adjacent to the specular (gloss) angle. The surface has less reflective contrast and a shallow milky effect. Usually a good appearance performance is defined by gloss (20°)>85 and Haze <20 at the same time.

1. A coating composition obtained by mixing components of
a) a resin and/or hardener;
b) a sagging control agent (SCA) reactive to resin and/or hardener; and
c) a catalyst.

2. The coating composition according to claim 1, wherein the SCA is at least one selected from the group consisting of silane based SCA, hydroxyl group based SCA, and carbon double bond based SCA.

3. The coating composition according to claim 1, wherein the silane based SCA is obtained by a reaction of a multi-isocyanate of Formula (I):
R⁵—(NCO)_{y} Formula (I)
and a silane compound of Formula (II): 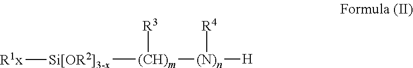
wherein R¹ is independently a C₁-C₁₂ alkyl group; R² is independently a C₁-C₆ alkyl group; R³ is independently a hydrogen or C₁-C₃ alkyl group; R⁴ is independently a hydrogen or methyl or ethyl group; R⁵ is independently a C₁-C₄ alkylene group or C₆-C₁₀ aryl group; y is an integer from 2 to 3; m is an integer from 1 to 3; n is an integer from 1 to 2; and x is an integer from 0 to 2.

4. The coating composition according to claim 3, wherein the silane based SCA has a structure of Formula (III): 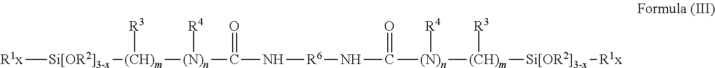
wherein R¹ is independently a C₁-C₁₂ alkyl group; R² is independently a C₁-C₆ alkyl group; R³ is independently a hydrogen or C₁-C₃ alkyl group; R⁴ is independently a hydrogen or methyl or ethyl group; R⁶ is independently a C₁-C₄ alkylene group or C₆-C₁₀ aryl group; m is an integer from 1 to 3; n is an integer from 1 to 2; and x is an integer from 0 to 2.

5. The coating composition according to claim 1, wherein the hydroxyl group based SCA is preferably obtained by a reaction of a multi-functional isocyanate with at least one hydroxy alkylamine in a liquid organic medium comprising at least one hydroxy-functional resin selected from the group consisting of polyacrylate, polyester, polyurethane, and polycarbonate, and at least one organic solvent selected from the group consisting of butylacetate, solvent naphtha, dimethylsulfoxide, and N-Methyl-2-pyrrolidone.

6. The coating composition according to claim 1, wherein the carbon double bond based SCA is obtained by a reaction of an isocyanic (meth)acrylate with at least one multi-functional alkylamine in a liquid organic medium comprising at least one (meth)acrylate-based reactive diluent selected from the group consisting of trimethylolpropane triacrylate and 1,6-hexanediol diacrylate and/or at least one organic solvent selected from the group consisting of butylacetate, solvent naphtha, dimethylsulfoxide, and N-Methyl-2-pyrrolidone.

7. The coating composition according to claim 1, wherein the resin is a vinyl silane containing polyacrylate and/or a vinyl silane containing copolymer of acrylate and styrene and/or an unsaturated polyester.

8. The coating composition according to claim 7, wherein the unsaturated polyester is obtained from a reaction of itaconic acid, hexahydrophthalic anhydride and acrylated-based reactive diluent.

9. The coating composition according to claim 1, wherein the hardener is a blocked polyisocyanate hardener.

10. The coating composition according to claim 1, further comprising at least one component selected from the group consisting of an initiator, a reactive diluent, a co-solvent and a leveling agent.

11. The coating composition according to claim 1, wherein its solid content is no less than 60% by weight.

12. The coating composition according to claim 1, wherein the ratio of low shear viscosity η₂ and high shear viscosity η₁ is no less than 2.

13. The coating composition according to claim 1, wherein its VOC (volatile organic compounds) content is less than 400 g/L.

14. A method of preparing the coating composition according to any claim 1 by mixing the resin the SCA the catalyst and an optional initiator, a leveling agent, a reactive diluent and a co-solvent.

15. A method of preparing the coating composition according to claim 1 by mixing Component I comprising the resin, the SCA and an optional reactive diluent and co-solvent, and Component II comprising the hardener, the catalyst and an optional initiator and leveling agent.

16. A method of preparing the coating composition according to claim 1, the method comprising mixing the SCA, the hardener, and the catalyst.

17. A method of preparing the coating composition according to claim 1, the method comprising mixing Component I comprising the SCA and the catalyst, and Component II comprising the hardener.

18. A method of using the coating composition according to claim 1, the method comprising using the coating composition in an automotive to form a clearcoat.

19. A clearcoat obtained by curing the coating composition according to claim 1.

20. The clearcoat according to claim 19, wherein a MEK (methylethylketone) double rub value of the clearcoat is no less than 300.

21. The clearcoat according to claim 19, wherein a gloss (20°) value of the clearcoat is no less than 85% and a haze value of the clearcoat is less than 20.
